(19) United States
(12) Patent Application Publication
(10) Pub. No.: US 2019/0250634 A1
(43) Pub. Date: Aug. 15, 2019

(54) VEHICLE, SYSTEM AND METHOD FOR REMOTE CONVOYING

(71) Applicant: CYCLECT ELECTRICAL ENGINEERING PTE LTD, Singapore (SG)

(72) Inventors: Weng Wah KHONG, Singapore (SG); Hideharu YANAGI, Singapore (SG); Chin Keong SEE, Singapore (SG)

(73) Assignee: CYCLECT ELECTRICAL ENGINEERING PTE LTD, Singapore (SG)

(21) Appl. No.: 16/347,549

(22) PCT Filed: Nov. 9, 2017
(86) PCT No.: PCT/SG2017/050562

§ 371 Date: May 3, 2019

(30) Foreign Application Priority Data
Nov. 9, 2016 (SG) 10201609375X

(51) Int. Cl. G05D 1/02; G05D 1/00; G06K 19/077; G06K 7/10

(52) U.S. Cl. CPC G05D 1/0278; G05D 1/0268; G05D 2201/0216; G06K 19/07758; G06K 7/10366; G05D 1/0011

(57) ABSTRACT

The present invention relates to a vehicle, capable of moving relative to a second vehicle, comprising a first global positioning system operable to determine a first positional information; a first identification means arranged to receive a first destination information of the first vehicle; a first communication means operable to send the first positional information and first destination information to a command center and further operable to receive a first navigation instruction from the command center, wherein the first navigation instruction is determined by way of the first destination information, the first positional information, a second destination information and a second positional information of the second vehicle; and a first processor operable to process the first navigation instruction and send a first control signal to move the first vehicle at a position relative to the second vehicle.

### FIELD OF INVENTION

The present invention relates to a vehicle, a system, and a method for remotely convoying a plurality of such vehicles. In particular, but not exclusively, this vehicle, system and method is suitable for, remotely convoying a plurality of baggage trolleys.

### BACKGROUND ART

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Currently, loading and unloading of baggage and cargo for narrow-body, non-containerised aircraft such as the airbus A320 and Boeing 737 is facilitated by baggage carts or trolleys that are linked together by tow-links 102 to one or more tow trucks 104 as shown in FIG. 1. However, different planes have different baggage capacity and within the same plane, the number of baggage carts or trolleys that are required differ from flight to flight. Consequently, labour is required to de-link baggage trolleys or link additional baggage trolleys to cater to the capacity of each flight.

Additionally, the use of tow trucks 104 also results in several other logistical inefficiencies in baggage handling. For example during unloading of baggage, a tow truck 104 and a plurality of baggage trolleys may only be despatched to the baggage claim conveyer system after all the baggage trolleys are loaded. This leads to an increase in the waiting time for passengers at the baggage claim area because the baggage trolleys have to move together with the tow truck 104.

In view of the above, there exists a need for a better solution to ameliorate the aforementioned problems at least through providing a remote system for convoying a plurality of baggage trolleys.

### SUMMARY OF THE INVENTION

In accordance with a first aspect of the invention there is a first vehicle, capable of moving relative to a second vehicle, comprising a first global positioning system operable to determine a first positional information; a first identification means arranged to receive a first destination information of the first vehicle; a first communication means operable to send the first positional information and first destination information to a command center and further operable to receive a first navigation instruction from the command center, wherein the first navigation instruction is determined by way of the first destination information, the first positional information, a second destination information and a second positional information of the second vehicle; and a first processor operable to process the first navigation instruction and send a first control signal to move the first vehicle at a position relative to the second vehicle. Advantageously, the first vehicle can be remotely convoyed with the second vehicle to be navigated to the destination.

Preferably, the first destination information is a destination of a first object placed on the first vehicle and the second destination information is a destination of a second object placed on the second vehicle.

Preferably, the first destination information is determined by way of a first Radio-frequency identification (RFID) tag attached to the first object and the second destination information is determined by way of a second RFID tag attached to the second object.

Preferably, the first object is a first baggage and a second object on the second vehicle is a second baggage.

Preferably, the first identification means is a first RFID reader for reading the first RFID tag and the second identification means is a second RFID reader for reading the second RFID tag.

Preferably, the first vehicle further comprising of a link platform configured to be attached to the second vehicle for the purpose of moving the first baggage from the first vehicle to the second vehicle or moving the second baggage from the second vehicle to the first vehicle.

Preferably, the first communication means is any one of the following: Zig-Bee, WiFi, Bluetooth, wireless local area network, cellular communication or wired connection.

In accordance with a second aspect of the invention, there is a method for moving a first vehicle relative to a second vehicle comprising the steps of: determining a current first positional information of the first vehicle; receiving a first destination information of the first vehicle; sending the current first positional information and first destination information to a command center; receiving a first navigation instruction from the command center, wherein the first navigation instruction is determined by way of the first destination information, the first positional information, a second destination information of the second vehicle and a second positional information of the second vehicle; processing the first navigation instruction; and sending a first control signal to move the first vehicle at a position relative to the second vehicle based on at least the processed first navigation instruction. Advantageously, the first vehicle can be remotely convoyed with the second vehicle to be navigated to the destination.

Preferably, the first destination information is a destination of a first object placed on the first vehicle and the second destination information is a destination of a second object placed on the second vehicle.

Preferably, the first destination information is determined by way of a first Radio-frequency identification (RFID) tag attached to the first object and the second destination information is determined by way of a second RFID tag attached to the second object.

Preferably, the step of receiving the first destination information of the first object placed on the first vehicle is by way of a first RFID reader for reading the first RFID tag.

Preferably, the first object is a first baggage and the second object is a second baggage.

Preferably, the step of moving the first baggage from the first vehicle to the second vehicle or moving the second baggage from the second vehicle to the first vehicle using a link platform.

Preferably, the current first positional information and first destination information is sent to a command center by any one of the following: Zig-Bee, WiFi, Bluetooth, wireless local area network, cellular communication or wired connection.

In accordance with a third aspect of the invention, there is a method for remote convoying a first vehicle relative to a second vehicle comprising the steps of: receiving a first destination information of the first vehicle and a second destination information of the second vehicle; receiving a first positional information of the first vehicle and a second positional information of the second vehicle; determining a first navigation instruction and a second navigation instruction by way of the first destination information, the first positional information, a second destination information of a second object on the second vehicle and a second positional information of the second vehicle; and transmitting the first navigation instruction to the first vehicle and the second navigation instruction to the second vehicle, wherein the first vehicle moves at a position relative to the second vehicle based on at least the first navigation instruction and the second navigation instruction.

Advantageously, the first vehicle can be remotely convoyed with the second vehicle to be navigated to the destination.

Preferably, the first destination information is determined by way of a first Radio-frequency identification (RFID) tag attached to a first object on the first vehicle and the second destination information is determined by way of a second RFID tag attached to a second object on the second vehicle.

Preferably, the first object is a first baggage and the second object is a second baggage.

Other aspects of the invention will become apparent to those of ordinary skilled in the art upon review of the following description of specific embodiments of the invention in conjunction with the accompanying figures.

### BRIEF DESCRIPTION OF THE DRAWINGS

The present invention will now be described, by way of example only, with reference to the accompanying drawings, in which:

FIG. 1 is a prior art system showing the (a) top view and (b) side view of a plurality of baggage trolleys linked to a tow truck via tow-links.

FIG. 2 shows a system comprising of a central command centre for remote convoying a plurality of baggage carts or trolleys.

FIG. 3 shows an electronic block diagram of the control unit of the smart trolley.

FIG. 4 illustrates the navigation of smart trolleys from a Trolley Staging Area that is equipped with a battery charging facility to a baggage loading carousel, wherein the smart trolleys may move individually or in a convoy.

FIG. 5 illustrates baggage loading and unloading into a cargo storage of an aircraft during departure and arrival respectively.

FIG. 6 illustrates baggage unloading of the smart trolleys at a carousel, wherein the baggage is unloaded into two carousel, one for direct flight and the other for transfer.

FIG. 7 illustrates the initialization of a convoy of smart trolleys which are initially parked in the Trolley Staging Area.

FIG. 8 shows the re-arrangement of a linear convoy into a 2×2 convoy.

FIG. 9 shows the de-linking of one trolley from a convoy during navigation.

### DESCRIPTION OF EMBODIMENTS OF THE INVENTION

Throughout the specification, unless the context requires otherwise, the word “comprise” or variations such as “comprises” or “comprising, will be understood to imply the inclusion of a stated integer or group of integers but not the exclusion of any other integer or group of integers.

Furthermore, throughout the specification, unless the context requires otherwise, the word “include” or variations such as “includes” or “including” will be understood to imply the inclusion of a stated integer or group of integers but not the exclusion of any other integer or group of integers.

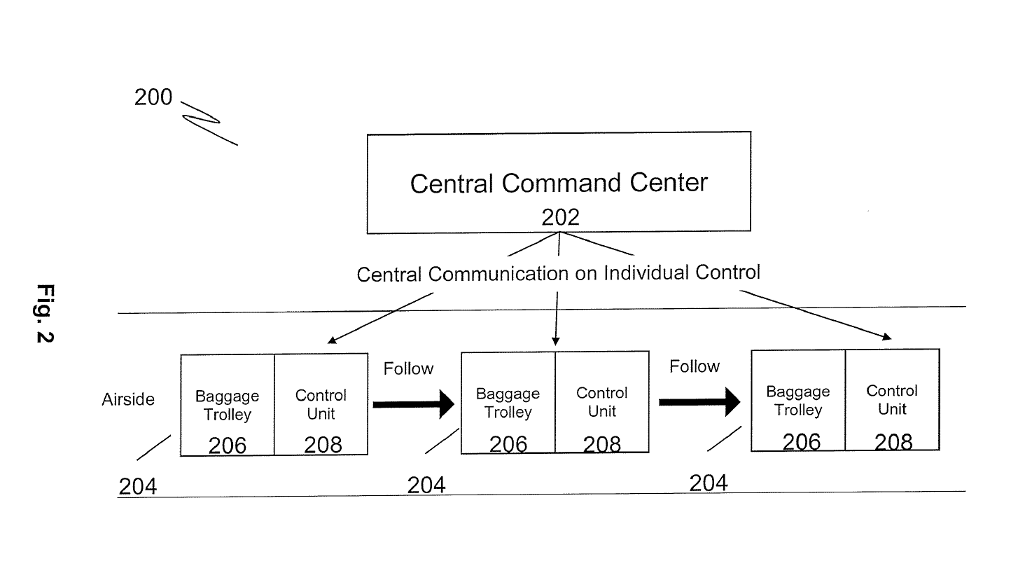

In accordance with various embodiments of the invention as shown in FIG. 2, there is a system 200 for remotely convoying a plurality of smart trolleys 204. The system 200 comprises a central command center 202 that is operable to communicate remotely with the control unit 208 of the plurality of smart trolleys 204. The remote communication may be via a wired or wireless communication means. Non-limiting examples of the wireless communication means may be based on Zig-Bee communication protocol, Bluetooth, WiFi, wireless local area network (WLAN), terrestrial microwave, communications satellites, cellular, radiowave of varying frequencies, or spread spectrum technologies.

Through the remote communication, the central command center 202 may be able to receive individual positional coordinates and other identification information from each smart trolley 204. Based on the received positional coordinates and the other identification information, the central command center 202 may perform calculations using a pre-determined logic to 1) plan a route for the convoy and/or 2) remotely convoy a plurality of smart trolleys 204 into a convoy formation based on the planned route. Thereafter, the central command center 202 may transmit control signals to each smart trolley 204 individually to 1) initialize the plurality of smart trolleys 204 into the convoy formation and 2) navigate the smart trolleys along the planned route in the convoy formation.

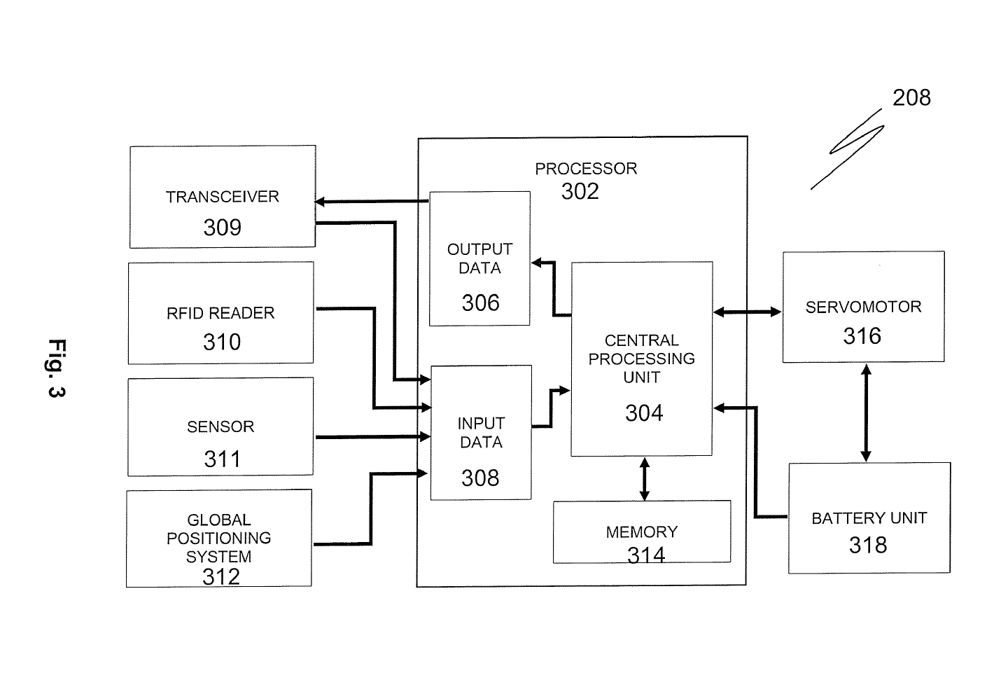

In various embodiments, each smart trolley 204 comprises a baggage trolley 206 and a control unit 208. As shown in FIG. 3, the control unit 208 comprises various electronic components or hardware for equipping the baggage trolley with remote convoying and remote navigation capability. The control unit 208 comprises a processor or processing unit 302 which is operable to process input data 308 using a central processing unit 304, wherein the input data 308 in the form of a control signal may be obtained from a transceiver 309 (otherwise may also be known as a communication means) that is in communication with the central command center 202. In various embodiments, input data 308 in the form of the positional coordinate of the smart trolley 204 may also be obtained from a global positioning system 312. After processing the input data 308, the central processing unit 304 may be further operable to either store the processed results in a memory 314 for future action or transmit the results as a data output 306 through the transceiver 309 to the command center 202.

In various embodiments, the input data 308 may be obtained from an identification means such as a Radio Frequency Identification (“RFID”) reader or RFID transceiver 310 operable to read an RFID tag or a barcode scanner operable to scan a barcode (not shown). In such a case, once the RFID tag is read by the reader 310 the data is sent by the reader 310 to the data processing unit 302. As the baggage is loaded or unloaded onto the smart trolley 204, the RFID reader 310 may read a RFID tag associated with the loaded baggage and capture important information relating to the baggage including, but not limited to, the intended flight identifier or number, destination, weight, size and owner details. Subsequently, the smart trolley 204 may transmit the information back to the central command center 202 for route planning purposes. In various embodiments, all the baggage loaded on a single smart trolley belong to the same flight. Hence, the central command center 202 may link and convoy smart trolleys loaded with baggage belonging to the same flight. In various embodiments, the baggage size information may also facilitate intelligent loading of the convoy of smart trolleys so as to increase the packing density of each smart trolley.

If the input data 308 is a control signal or navigation instruction from the central command center 202, the central processing unit 304 may be operable to process the control signal and send another control signal or command signal to a servomotor 316 for driving a wheel of the smart trolley 316. In various embodiments, there may be two wheels which are driven independently by two separate servomotors 316 so as to steer the smart trolley 204 using differential steering in which one of the wheels is rotating faster than the other to effect steering. In various embodiments, the power to the servomotor 316 and/or the central processing unit 304 may be supplied by a battery unit 318 and the battery unit 318 may be rechargeable.

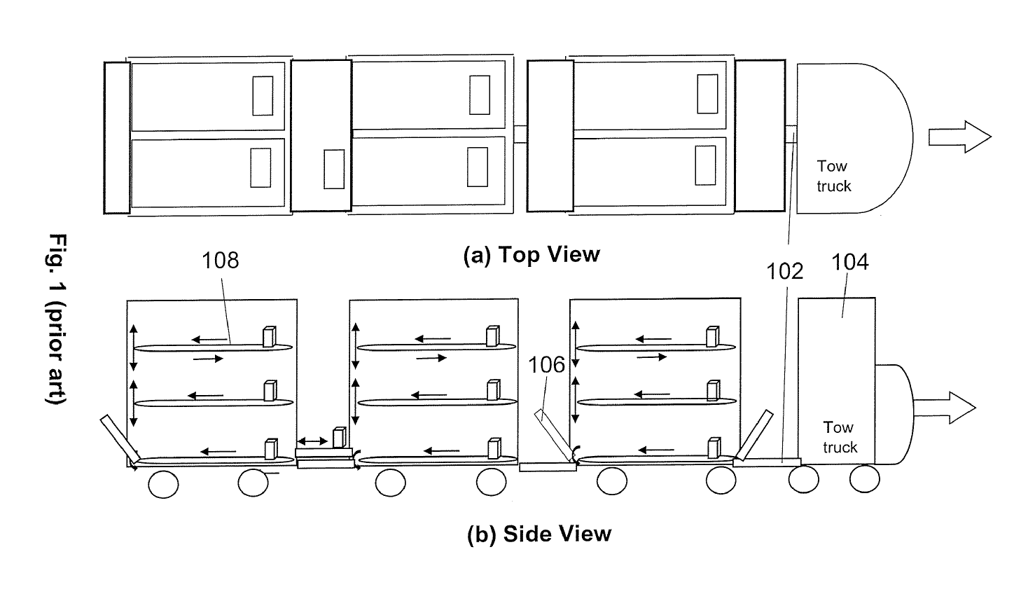

In various embodiments, when the smart trolleys 204 are navigating in a convoy formation, each smart trolley 204 may comprise a front and/or a back door, the front or back door facing an adjacent smart trolley 204. The front and/or back door may be lowered to act as a link platform 106 to the adjacent smart trolley 204. The link platform functions similarly as tow-links 102. Each link platform 106 may also comprise a conveyor belt for transferring or moving baggage from one smart trolley to the adjacent smart trolley. In various embodiments similar to FIG. 1, each smart trolley 204 may also comprise a plurality of shelves 108 wherein each of the plurality of shelves 108 may comprise a conveyor belt operable to move baggage along the shelf 108. Further, the plurality of shelves 108 may also be operable to be raised or lowered to a plurality of locations between the top side and the base. The link platform 106 of the adjacent smart trolley may also be connected to a conveyor belt ramp (not shown) for the purpose of loading and unloading.

Consequently, the conveyor link platforms 106 and the conveyor shelves 108 that is capable of being lowered to the level of the link platforms 106 enable baggage to be loaded and unloaded through any smart trolley 204 in the convoy (i.e. either the front, middle or rear smart trolley). For example, baggage from any shelves 108 of the rear smart trolley may be moved by the link platform 106 to the front smart trolley for unloading through a ramp. Similarly, baggage from any shelves 108 of the front smart trolley may be also be moved by the link platform 106 to the rear smart trolley 406 for unloading through the ramp. Advantageously, there is no need to remove the first smart trolley after the baggage has been loaded or unloaded, align the second smart trolley to the ramp for loading or unloading, remove the second smart trolley after loading or unloading is completed, followed by aligning the third smart trolley to the ramp for loading or unloading. This enhances logistical efficiency by saving time as the total time required to unload or load all the baggage from each of the smart trolleys in a linear convoy to the ramp is reduced as compared to the time taken for the conventional method of loading and unloading baggage smart trolleys individually from the ramp.

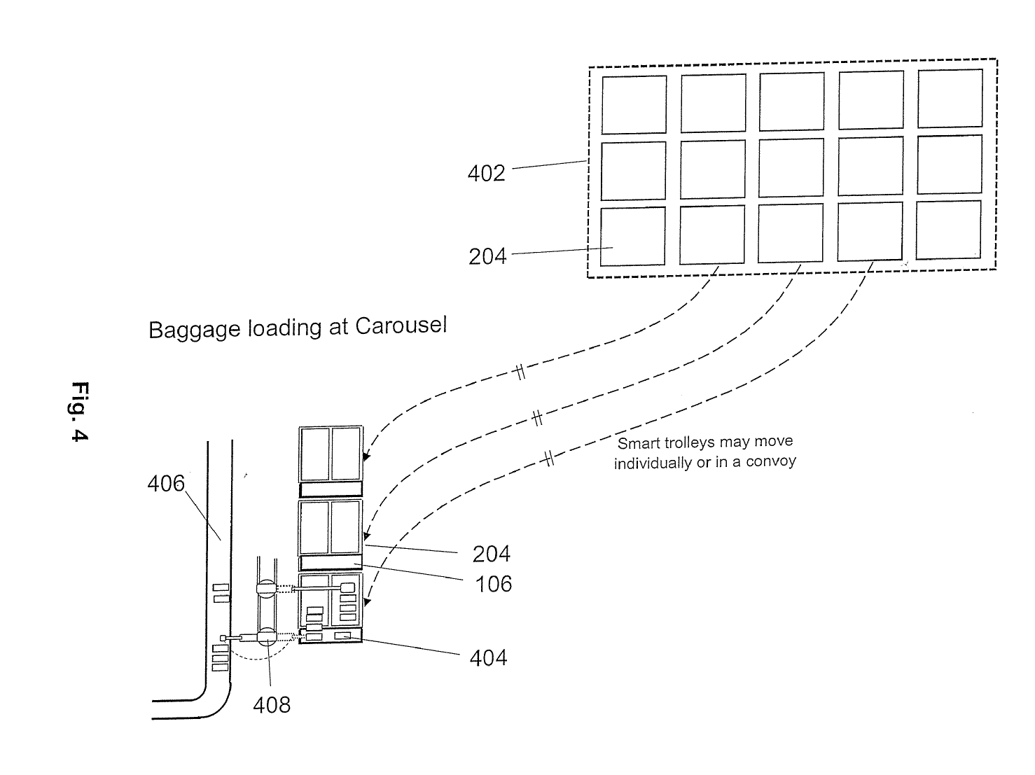

The present invention will now be described in greater technical detail relating to its operation modes, in accordance with at least FIGS. 4 to 9. As shown in FIG. 4, empty smart trolleys 204 may be parked initially in a Trolley Staging Area 402 (TSA) which is equipped with a battery charging facility. When there is a demand for baggage transportation for a departing flight, empty smart trolleys 204 may then be remotely navigated by the central command center 202, either individually or in a convoy, to a baggage loading carousel 406 for loading an object or baggage 404 checked-in by passengers for a flight. The baggage may be loaded from the loading carousel 406 to the smart trolleys 204 by way of a ramp or conveyor belt 408. During the loading of baggage 404, a tag on each baggage 404 may be read or scanned by the smart trolleys 204 before the baggage 404 is placed on the smart trolley 204. Thereafter, information of each baggage may be sent to the central command center 202. In various embodiments, the tag may be a RFID tag or a Quick Response (QR) code. In various embodiments, the destination may also be obtained manually from a user via a data entry means at either the smart trolley 204 or the central command center 202.

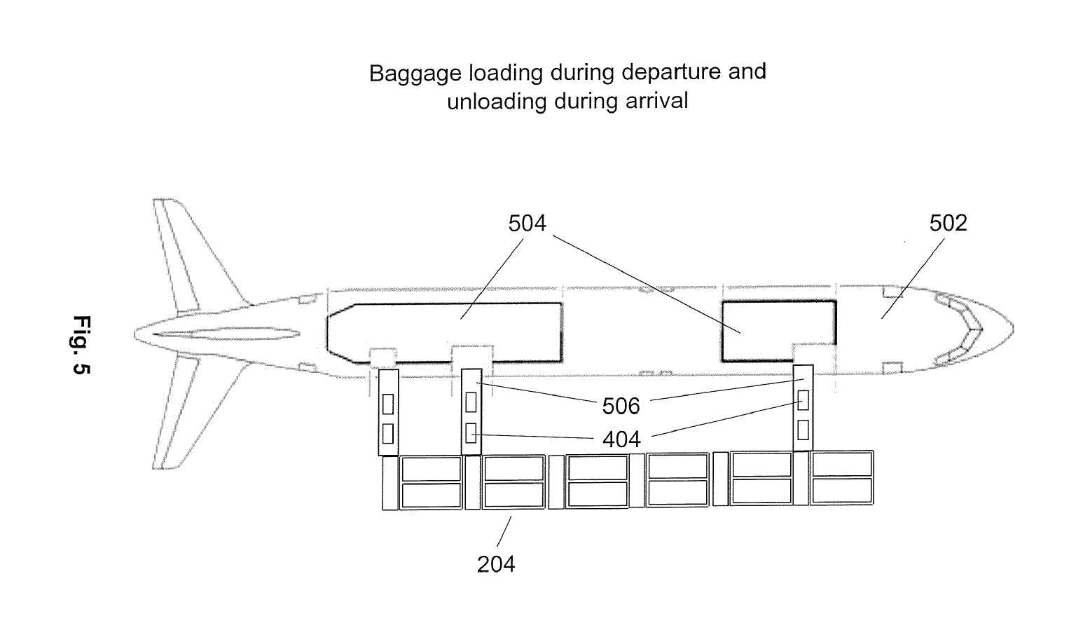

Based on at least the received information (such as the intended flight and/or destination of baggage) from the tag and/or by manual entry, the central command center 202 may be operable to plan a route of navigation for each individual trolley 204 or the convoy of trolleys from the baggage loading carousel to the intended destination, i.e. the aeroplane. When the trolleys reached the intended destination as shown in FIG. 5, baggage 404 may be unloaded to a cargo storage 504 of the aeroplane 502 via ramps 506.

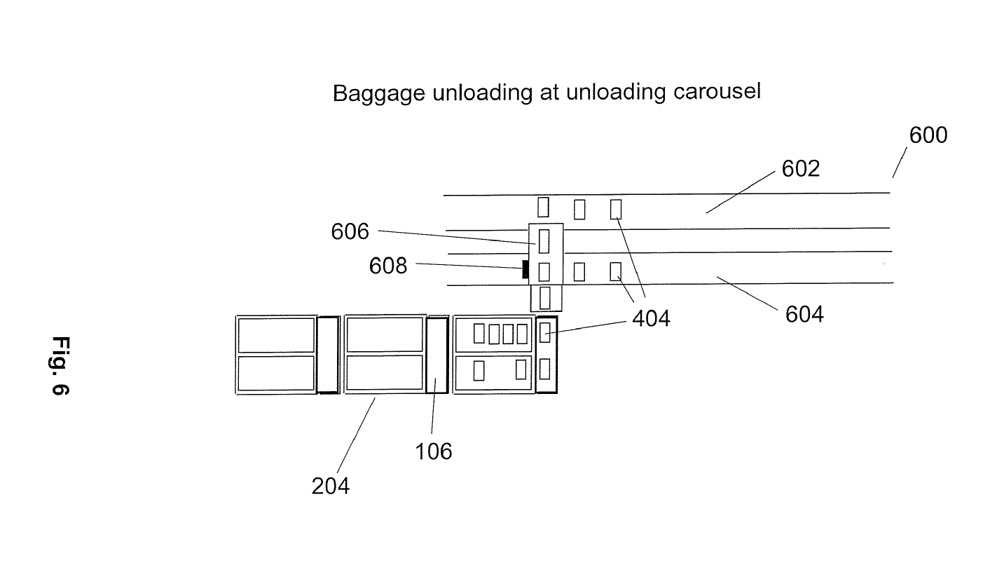

In another scenario when there is a demand to unload baggage from an arriving flight, empty smart trolleys 204 initially parked in the Trolley Staging Area 402 (TSA) may also be remotely navigated to the arriving aeroplane 504, either individually or in a convoy, for unloading baggage 404 from a flight as shown in FIG. 5. Thereafter, the smart trolleys 204 may be loaded with baggage 404, and the loaded smart trolleys 204 may then be remotely navigated by the central command center 202, either individually or in a convoy, from the aeroplane to an unloading carousel 600 (may also be known as a Break Carousel) for baggage unloading as shown in FIG. 6. The baggage may then be unloaded into either of two carousels at the unloading carousel 600, wherein baggage intended to be transferred to another flight (transfer) is unloaded onto a first carousel 602 and baggage intended for the baggage claim (direct flight) is unloaded onto a second carousel 604. The unloading of baggage at the unloading carousel 600 into either of the first carousel 602 or the second carousel 604 may be achieved by way of a ramp 606 which may be a conveyor belt. A baggage sorter 608 may be incorporated into the ramp 606 to sort the baggage into the first carousel 602 or the second carousel 604 according to their next destination by scanning the RFID tag on the baggage. In various embodiments, the baggage sorter 608 may comprise of either a RFID reader or a QR code scanner for reading the RFID tag or QR code on each baggage respectively.

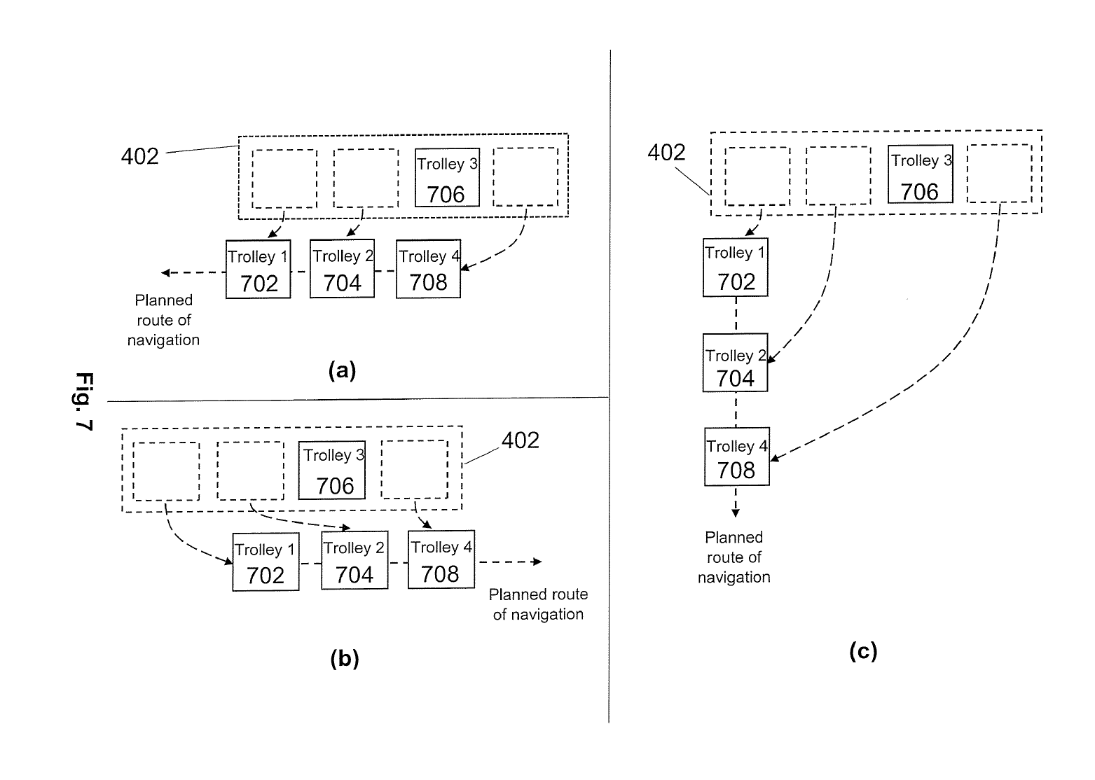

As described above, the smart trolleys 204 may be remotely navigated in a convoy by the central command center 202 from the TSA to a target destination, either baggage loading carousel 406 or aeroplane 502 or unloading carousel 600. FIG. 7 illustrates two examples in which smart trolleys 204 may be initialized in a convoy at the TSA before navigating to the intended destination. In various embodiments, a plurality of empty smart trolleys (702, 704, 706, 708) may be parked and on standby in the TSA initially. When there is a demand for baggage transportation, the first smart trolley 702, second smart trolley 704 and fourth smart trolley 708 are identified or selected by the central command center 202 to be grouped together as a convoy. In this case, the third smart trolley 706 may not be selected by the central command center 202 to be part of the convoy due to several possible reasons, such as being low in battery or due to malfunctioning. In various embodiments, each of the plurality of smart trolleys may have different size and capacity. Consequently, the central command center 202 may be able to select the convoy of smart trolleys to meet the required load capacity.

After the convoy of smart trolleys is remotely identified or selected, the central command center 202 may be operable to plan a route of navigation for the convoy to the intended destination. Thereafter, the central command center 202 may determine the position of each smart trolley (702, 704 or 708) within the convoy arrangement or formation based on the planned direction of navigation and the current positional coordinates of the respective smart trolley (702, 704 or 708) that is parked or stationed in the TSA. For example, as shown in FIG. 7 (a), the first smart trolley 702 may be determined to be the front smart trolley along a single-file formation because its initial position is located closest to the front position along the planned route of navigation. Similarly, the fourth smart trolley 708 may be determined to be rear smart trolley in the convoy arrangement because it is located closest to the rear position. Advantageously, the foregoing technical feature may enable the convoy formation (i.e. single-file convoy formation) to be formed in the shortest amount of time. FIG. 7 shows that all the smart trolleys 204 are oriented in the same direction. However, in various embodiments, the orientation of each smart trolley 204 may be different. Consequently, the process of aligning the smart trolleys to form a convoy may also be dependent on the initial position or orientation of the smart trolleys 204 when it is stationed inside the TSA.

Conversely and as shown in FIG. 7 (b) and (c), the respective positions of the smart trolleys may be different if the planned route of navigation is pointed towards a different direction. In the case as illustrated in FIG. 7 (b), the fourth smart trolley 708 may be determined to be the front trolley and the first smart trolley 702 is determined to occupy the rear position.

In various embodiment, the position of each smart trolley (702, 704 or 708) within the convoy formation may be based on a priority information instead of being based on the planned direction of navigation and the current positional coordinates of the individual smart trolleys. For example a smart trolley (702, 704 or 708) that is pre-assigned or pre-classified in advance to have a higher priority (for example for baggage belonging to first class passengers) may be placed in the front of the convoy regardless of its initial position. Conversely, the smart trolley (702, 704 or 708) that is pre-assigned to have a lower priority (for example for baggage belonging to economy class passengers) may occupy the rear position or vice versa . In various embodiments, the pre-assignment or pre-classification may be performed by the central command center 202. In various embodiments, the priority information of each baggage may be determined via reading the tag attached to the baggage when it is loaded into one of the smart trolley (702, 704 or 708) in the convoy. Thereafter, the use of link platforms 106 between adjacent smart trolleys (702, 704 or 708) in the convoy and the movable shelf 108 in each smart trolley (702, 704 or 708) allows the baggage to be moved or transported from the smart trolley (702, 704 or 708) in which the baggage is loaded to the smart trolley (702, 704 or 708) that is pre-assigned for level of priority for the baggage.

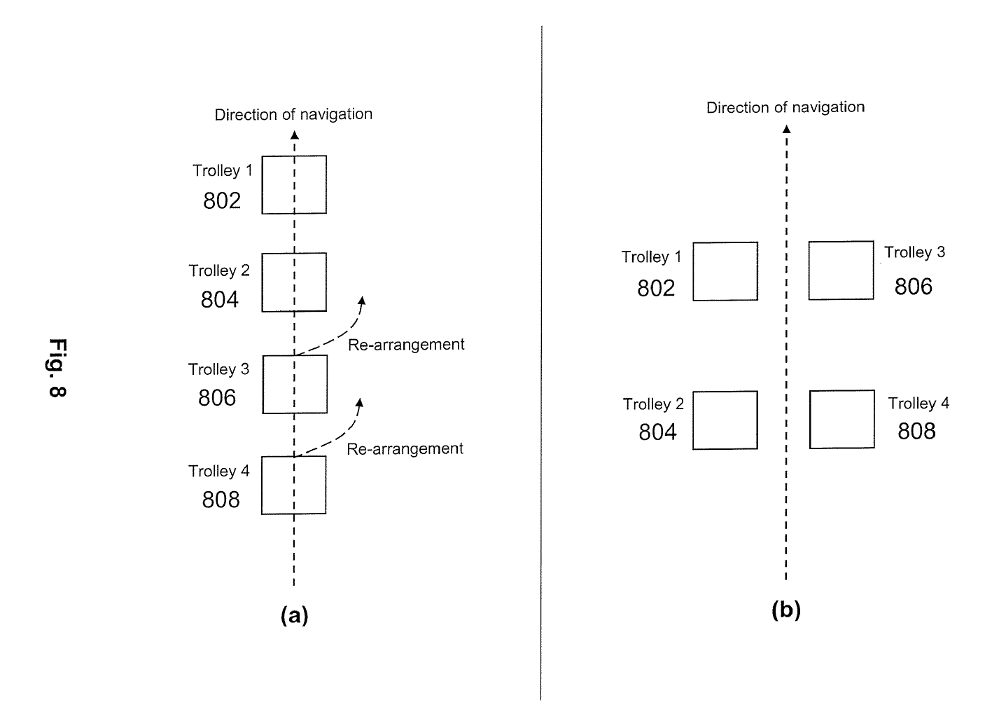

In various embodiments as shown in FIG. 8 (b), the convoy formation may also be two-dimensional such as a 2 by 2 formation instead of being linear or single-file. A 2 by 2 convoy formation may be advantageous in situations when the available room or space for navigation is sufficiently wide or broad. In various embodiments as shown in FIG. 7 (a) and (b), the convoy formation may also be dynamically changed during navigation between a two-dimensional formation (2 by 2) and a one-dimensional formation (single-file or linear) depending on traffic conditions en route.

Referring back to FIG. 7, after the position of each smart trolley (702, 704 and 708) within the convoy formation is determined, the central command center 202 may then transmit individual control signals to the smart trolleys for navigation. It may be appreciated that navigation may be achieved in at least two different embodiments of operation:

1. Passive Remote Convoy Navigation:

In passive remote convoy navigation, unique navigation instructions and/or control signals are transmitted in advance by the central command center 202 to each smart trolley (702, 704 or 708) to effect convoy navigation to the intended destination while maintaining in the pre-defined convoy formation. Each unique navigation instruction to the corresponding smart trolley (702, 704 or 708) is determined by the central command center 202 at least by way of the destination information and/or positional information or coordinates of every smart trolley in the convoy to ensure that all the smart trolleys (702, 704 and 708) in the convoy navigate in unison or synchronization. In various embodiments, the planned route of navigation may be represented by a series of positional nodes which may be expressed in the geographic coordinate system with at least latitude and longitude coordinates. The series of positional nodes of the planned route may then be transmitted to the smart trolleys (702, 704 and 708) along with other information such as the navigation speed between any two adjacent nodes and the estimated time of arrival (ETA) at each positional node. Having a unique ETA for each smart trolley at every positional node may avoid collision between the smart trolleys.

As the navigation instructions are sent in advance, the central processing unit 304 of each smart trolley (702, 704 or 708) may be operable to store the navigation instructions in the memory 314 for subsequent execution. When the smart trolley (702, 704 or 708) arrives at each positional node, the respective central processing unit 304 may be operable to retrieve the navigation instruction which may contain the speed, direction and ETA for navigation to the next positional node. Thereafter, the central processing unit 304 may then send a control signal to the servomotor 316 to effect navigation to the next positional node in accordance with the navigation instructions.

In various embodiments, the central command center 202 may also actively monitor the position of each smart trolley to ensure that they are navigating according to the planned route. The central command center 202 may also actively monitor the planned route via a network of video surveillance cameras (not shown) for anomaly. If traffic is detected along the planned path or a physical object is detected to be obstructing the planned route by the network of video surveillance cameras, the central command center 202 may then issue new navigational instructions to each smart trolley (702, 704 or 708) to navigate around the traffic ahead or the physical obstruction. The new navigational instructions may then override the old navigational instructions. It may be appreciated that central command center 202 may have taken into account the presence of physical obstructions and/or traffic when planning the initial navigation route but it may be challenging from predicting traffic that are not controlled by the central command center 202 or the sudden appearance of any physical obstructions. Some examples of traffic may be a taxiing plane or other types of vehicles moving on the airport apron or tarmac. In various embodiments, the central command center 202 may also transmit new navigation instructions to effect a new convoy formation depending on traffic conditions.

In various embodiments, the physical obstruction in close proximity may be detected by a sensor 311 on board any one of the smart trolleys (702, 704 or 708). In this situation, the smart trolley which has detected the physical obstruction may perform an emergency stop while transmitting an emergency stop message to the central command center 202. Subsequently, the central command center 202 may then transmit an emergency stop command to the other trolleys within the convoy to stop navigation. Upon receiving the emergency stop message from the smart trolley which has detected the physical obstruction, the central command center 202 may also plan a new route and issue new navigation instructions to navigate all the smart trolleys (702, 704 and 708) around the physical obstruction to the intended destination. Otherwise, the central command center 202 may also monitor the physical obstruction and transmit new navigation instructions to re-start navigation once the physical obstruction or traffic has passed by.

In various embodiments, the safety distance between each smart trolley (702, 704 or 708) may be determined at least based on the navigation speed of the trolleys (702, 704 and 708) and the response time from detection to braking during an emergency stop.

2. Dynamic Remote Convoy Navigation

In dynamic remote convoy navigation, unique navigation instructions are transmitted in real-time by the central command center 202 individually to each smart trolley (702, 704 or 708). In this case, the central processing unit 304 may process the unique navigation instruction immediately and transmit a control signal to the servomotor 316 to effect navigation.

In dynamic remote convoy navigation, the central command center 202 may also have real-time environmental or surrounding awareness by receiving real-time information from the sensor 311 of each smart trolley (702, 704 or 708) and/or a network of video surveillance cameras located in the vicinity or on board each smart trolley (702, 704 or 708). Consequently, the information gathered from the sensor 311 of each smart trolley (702, 704 or 708) and/or the network of surveillance cameras may allow dynamic planning of route to avoid collision with other vehicles or objects. The foregoing may also enable the convoy formation to be dynamically changed to adapt to different traffic conditions.

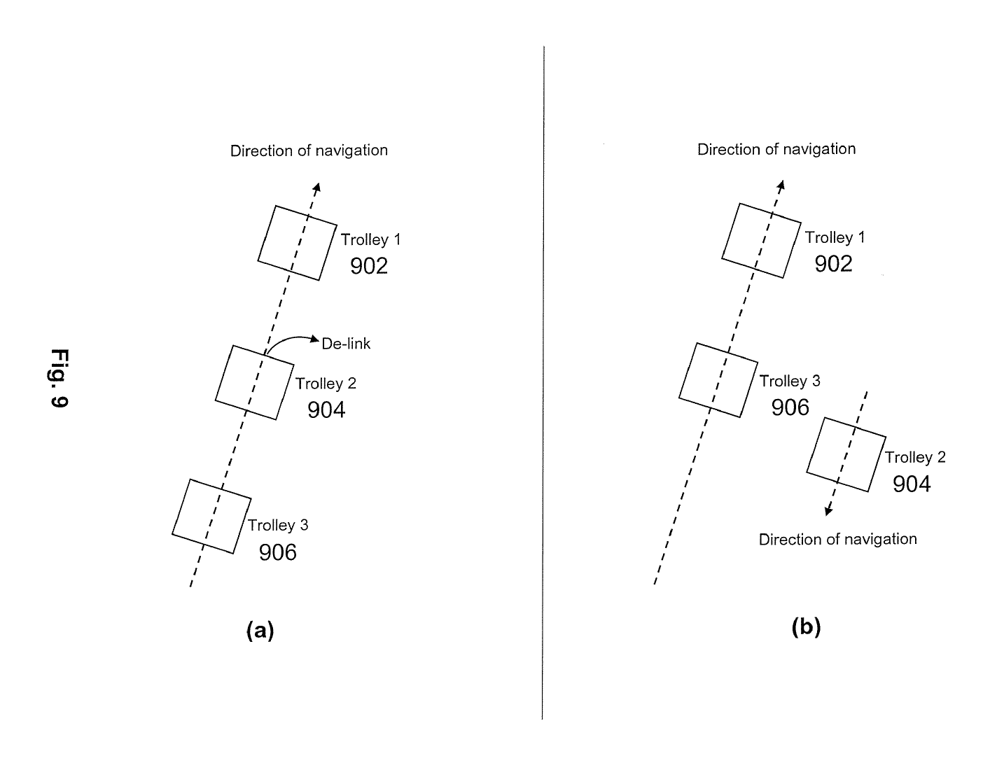

In various embodiments and as shown in FIG. 9, there may be a need for a smart trolley (in this case the second smart trolley 904) to leave or be de-linked from the convoy. If this situation occurs when the convoy is navigating to the intended destination, the central command center 202 may transmit a new set of navigation instructions to the smart trolleys (902, 904 and 906) to de-link the second smart trolley 904. As shown in FIG. 9 (b), the third smart trolley 906 may also be moved to the old position of the second smart trolley 904 relative or with respect to the first smart trolley 902. The second smart trolley 904 may then be navigated back to the baggage loading point or to a location where the baggage may be unloaded.

If the foregoing situation occurs when the convoy has already arrived at the intended destination and all the smart trolleys (902, 904 and 906) are stationary or parked at the unloading point of the intended destination, the central command center 202 may transmit a navigation instruction to the second trolley 904 to navigate or move out of the convoy whilst at the same time transmitting a navigation instruction to the third trolley 906 to move into the position that is vacated by the second trolley 904 as shown in in FIG. 9 (b).

In various embodiments, after the convoy of smart trolleys (702, 704 and 708) have arrived at the unloading point or the intended destination, the smart trolleys (702, 704 and 708) may be able to self-align with each other to ensure that the link platforms 106 may be connected the respective adjacent smart trolley. Each smart trolley (702, 704 or 708) may align itself to another smart trolley (702, 704 or 708) by using systems including Programmable Logic Controller (PLC) based alignment and positioning systems, GPS and/or a software, and each cart can be linked to another cart by means of a tow link 50. In various embodiments, the convoy of smart trolleys (702, 704 and 708) may also self-align with another convoy of smart trolleys.

It should be further appreciated by the person skilled in the art that variations and combinations of features described above, not being alternatives or substitutes, may be combined to form yet further embodiments falling within the intended scope of the invention. In particular:
The present invention may be applied to remotely convoy and navigate any number of smart trolleys, notwithstanding the illustrations in the Figures.
Although the present invention is described in the context of navigating smart trolleys, it may also be applied to convoy and navigate any types of vehicles.
The control unit 208 of the smart trolley 204 may be in the form of an add-on apparatus or designed integrally with the baggage trolley.
Although route planning is performed by the central command center 202, it may be appreciated that route planning may also be performed by one of the smart trolleys installed with the necessary processor unit and/or transceiver (communication means) to implement the route planning logic. In this case, the smart trolley planning the route may function as the central command center 202. In some embodiments, the smart trolley planning the route may be assigned to be the designated leader.
Vehicle-to-vehicle (V2V) communication may be implemented to facilitate information sharing between the smart trolleys. For example, the emergency stop message may be transmitted directly to the remaining vehicles instead of re-routed via the central command center 202 which would reduce the response time for emergency braking. In various embodiments, the navigation instructions may be transmitted to a leader smart trolley which would then relay the navigation instructions to each of the remaining smart trolleys individually through V2V communication.

1. A first vehicle, capable of moving relative to a second vehicle, comprising:
a first global positioning system operable to determine a first positional information;
a first identification means arranged to receive a first destination information of the first vehicle;
a first communication means operable to send the first positional information and first destination information to a command center and further operable to receive a first navigation instruction from the command center,
wherein the first navigation instruction is determined by way of the first destination information, the first positional information, a second destination information and a second positional information of the second vehicle; and
a first processor operable to process the first navigation instruction and send a first control signal to move the first vehicle at a position relative to the second vehicle.

2. The first vehicle according to claim 1, wherein the first destination information is a destination of a first object placed on the first vehicle and the second destination information is a destination of a second object placed on the second vehicle.

3. The first vehicle according to claim 2, wherein the first destination information is determined by way of a first Radio-frequency identification (RFID) tag attached to the first object and the second destination information is determined by way of a second RFID tag attached to the second object.

4. The first vehicle according to claim 2 or 3, wherein the first object is a first baggage and a second object on the second vehicle is a second baggage.

5. The first vehicle according to claim 3, wherein the first identification means is a first RFID reader for reading the first RFID tag and the second identification means is a second RFID reader for reading the second RFID tag.

6. The first vehicle according to any one of claims 1 to 5 further comprising of a link platform configured to be attached to the second vehicle for the purpose of moving the first baggage from the first vehicle to the second vehicle or moving the second baggage from the second vehicle to the first vehicle.

7. The first vehicle according to any one of claims 1 to 6, wherein the first communication means is any one of the following: Zig-Bee, WiFi, Bluetooth, wireless local area network, cellular communication or wired connection.

8. A method for moving a first vehicle relative to a second vehicle comprising the steps of:
determining a current first positional information of the first vehicle;
receiving a first destination information of the first vehicle;
sending the current first positional information and first destination information to a command center;
receiving a first navigation instruction from the command center,
wherein the first navigation instruction is determined by way of the first destination information, the first positional information, a second destination information of the second vehicle and a second positional information of the second vehicle;
processing the first navigation instruction; and
sending a first control signal to move the first vehicle at a position relative to the second vehicle based on at least the processed first navigation instruction.

9. The method according to claim 8, wherein the first destination information is a destination of a first object placed on the first vehicle and the second destination information is a destination of a second object placed on the second vehicle.

10. The method according to claim 9, wherein the first destination information is determined by way of a first Radio-frequency identification (RFID) tag attached to the first object and the second destination information is determined by way of a second RFID tag attached to the second object.

11. The method according to claim 10, wherein the step of receiving the first destination information of the first object placed on the first vehicle is by way of a first RFID reader for reading the first RFID tag.

12. The method according to any one of claims 8 to 11, wherein the first object is a first baggage and the second object is a second baggage.

13. The method according to any one of claims 8 to 12, further comprising the step of moving the first baggage from the first vehicle to the second vehicle or moving the second baggage from the second vehicle to the first vehicle using a link platform.

14. The method according to any one of claims 8 to 13, wherein the current first positional information and first destination information is sent to a command center by any one of the following: Zig-Bee, WiFi, Bluetooth, wireless local area network, cellular communication or wired connection.

15. A method for remote convoying a first vehicle relative to a second vehicle comprising the steps of:
receiving a first destination information of the first vehicle and a second destination information of the second vehicle;
receiving a first positional information of the first vehicle and a second positional information of the second vehicle;
determining a first navigation instruction and a second navigation instruction by way of the first destination information, the first positional information, a second destination information of a second object on the second vehicle and a second positional information of the second vehicle; and
transmitting the first navigation instruction to the first vehicle and the second navigation instruction to the second vehicle, wherein
the first vehicle moves at a position relative to the second vehicle based on at least the first navigation instruction and the second navigation instruction.

16. The method according to claim 15, wherein the first destination information is determined by way of a first Radio-frequency identification (RFID) tag attached to a first object on the first vehicle and the second destination information is determined by way of a second RFID tag attached to a second object on the second vehicle.

17. The method according to any one of claim 15 or 16, wherein the first object is a first baggage and the second object is a second baggage.
